(19) United States
(12) Patent Application Publication
(10) Pub. No.: US 2016/0257079 A1
(43) Pub. Date: Sep. 8, 2016

(54) SHAFT-SHAPED COMPOSITE MEMBER AND PRODUCTION METHOD THEREOF

(71) Applicant: HONDA MOTOR CO., LTD., Tokyo (JP)

(72) Inventors: Kazuhiro Taneda, Wako-shi (JP); Hiroshi Kiyomoto, Wako-shi (JP); Nobuhiro Yamada, Wako-shi (JP)

(73) Assignee: HONDA MOTOR CO., LTD., Tokyo (JP)

(21) Appl. No.: 15/059,667

(22) Filed: Mar. 3, 2016

(30) Foreign Application Priority Data
Mar. 3, 2015 (JP) 2015-041159

(51) Int. Cl. B29C 70/48; B32B 27/08; B32B 1/00

(52) U.S. Cl. CPC B29C 70/48; B32B 1/00; B32B 27/08; B32B 2250/02; B32B 2250/24; B32B 2262/106; B32B 2605/08; B29L 2023/004

(57) ABSTRACT

A bent part of a shaft-shaped composite member is formed by stacking a 0° layer located on a radial outer side and having a carbon fiber orientation direction parallel to an axial direction of the shaft-shaped composite member and a ±45° layer located on a radial inner side and having a carbon fiber orientation direction obliquely intersecting the axial direction of the shaft-shaped composite member. A stress relaxation layer is interposed between the 0° layer and the ±45° layer. The stress relaxation layer is set to have a flexural rigidity lower than a flexural rigidity of the 0° layer and a torsional rigidity lower than a torsional rigidity of the ±45° layer.

### CROSS REFERENCES TO RELATED APPLICATIONS

The present application claims priority under 35 U.S.C. §119 to Japanese Patent Application No. 2015-041159, filed Mar. 3, 2015, entitled “Shaft-Shaped Composite Member and Production Method Thereof.” The contents of this application are incorporated herein by reference in their entirety.

### TECHNICAL FIELD

The present disclosure relates to a shaft-shaped composite member and a production method therefor.

### BACKGROUND

In recent years, automobiles have been required to achieve weight reduction and strengthening of various members in order to enhance fuel economy performance, and for example, fiber reinforced resin, such as a carbon material, is used. As an example using fiber reinforced resin, Japanese Unexamined Patent Application Publication No. 3-166937 discloses a technical idea that a carbon fiber reinforced layer (fiber reinforced layer) is wound around an outer surface of a carbon fiber reinforced aluminum pipe (metallic shaft-shaped member) by using a rolling table.

Japanese Unexamined Patent Application Publication No. 2007-528 discloses a shaft for a golf club, which is formed by a fiber reinforced composite material made by stacking a plurality of carbon fibers having different orientation angles from an inner side toward an outer side.

For example, when a fiber reinforced resin material is used for a shaft-shaped composite member having a shape (bent part) with high curvature, such as a shaft-shaped composite member used in a frame structure body of an automobile, it is difficult to ensure rigidity of the frame structure body by winding the fiber reinforced resin material around the bent part. For example, when the above-described carbon fiber reinforced layer disclosed in Japanese Unexamined Patent Application Publication No. 3-166937 is wound around a linear core metal and the core metal is then bent, if the curvature of the bent part of the core metal increases, the carbon fiber reinforced layer wound around the outside of the bent part may expand and fracture.

### SUMMARY

It is desirable to provide a shaft-shaped composite member whose endurance can be increased by ensuring a predetermined strength of a bent part, and a production method for the shaft-shaped composite member.

According to one aspect of the present disclosure, there is provided a shaft-shaped composite member having a bent part. The bent part is formed by stacking a 0° layer having a carbon fiber orientation direction parallel to an axial direction of the shaft-shaped composite member and a ±45° layer having a carbon fiber orientation direction obliquely intersecting the axial direction of the shaft-shaped composite member. A stress relaxation layer is interposed between the 0° layer and the ±45° layer. The stress relaxation layer is set to have a flexural rigidity lower than a flexural rigidity of the 0° layer and a torsional rigidity lower than a torsional rigidity of the ±45° layer.

According to this aspect of the present disclosure, the 0° layer has rigidity against the flexural load applied to the bent part of the shaft-shaped composite member, and the ±45° layer has rigidity against the torsional load. At this time, a specific stress may be generated on an interface between the layers because the layers have different rigidities. For this reason, in the aspect of the present disclosure, the stress relaxation layer having a flexural rigidity lower than that of the 0° layer and a torsional rigidity lower than that of the ±45° layer is interposed between the 0° layer and the ±45° layer. By providing the stress relaxation layer, the stress generated on the interface between the layers is relaxed, and this can increase the strength (especially, fatigue strength applied repeatedly) of the interface. As a result, according to the aspect of the present disclosure, it is possible to increase the endurance by ensuring a predetermined strength of the bent part.

A conceivable method as an approach to increasing the strength is, for example, to increase the weight (rigidity) by increasing the thicknesses of the layers, instead of increasing the strength. According to the aspect of the present disclosure, however, the strength (especially, fatigue strength) can be increased without increasing the weight per unit dimension and without reducing rigidity, in contrast to the shaft-shaped composite member of the related art.

According to another aspect of the present disclosure, there is provided a production method for a shaft-shaped composite member having a bent part. The production method includes the steps of juxtaposing a plurality of carbon fiber reinforced resin materials parallel to an axial direction of cavities of a pair of molds, the carbon fiber reinforced resin materials having an orientation direction parallel to an axial direction of the shaft-shaped composite member, forming halved members by pressing the plurality of juxtaposed carbon fiber reinforced resin materials against the cavities, winding a ±45° material having a carbon fiber orientation direction obliquely intersecting the axial direction of the shaft-shaped composite member on a radial inner side of an outer surface of a tube material and winding a stress relaxation material having a flexural rigidity lower than a flexural rigidity of the halved members and a torsional rigidity lower than a torsional rigidity of the ±45° material on a radial outer side, inserting, into an inner side of the halved members, the tube material with the ±45° material and the stress relaxation material stacked on the outer surface thereof and closing the pair of molds to form a tubular member, and setting the tubular member by heating the tubular member while applying an internal pressure to the tubular member.

According to this aspect of the present disclosure, it is possible to easily produce a shaft-shaped composite member in which a stress generated on an interface between a 0° material and a ±45° material is relaxed and the strength (especially, fatigue strength repeatedly applied repeatedly) is increased by interposing a stress relaxation material between the 0° material and the ±45° material.

### BRIEF DESCRIPTION OF THE DRAWINGS

The advantages of the disclosure will become apparent in the following description taken in conjunction with the following drawings.

FIG. 1 is a perspective view of a shaft-shaped composite member produced by a production method for a shaft-shaped composite member according to an embodiment of the present disclosure.

FIG. 2 is a partly enlarged transparent perspective view of the shaft-shaped composite member of FIG. 1.

FIG. 3 is a cross-sectional view taken along line of FIG. 2.

FIG. 4A to 4G are schematic views illustrating a production procedure for producing the shaft-shaped composite member.

FIG. 5A is a characteristic view showing the relationship between the fiber orientation angle and the Young's modulus in a 0° layer, and FIG. 5B is a characteristic view showing the relationship between the fiber orientation angle and the elastic shear modulus in a ±45° layer.

FIG. 6 is an explanatory view comparing endurances between a comparative example having no stress relaxation layer and the embodiment having a stress relaxation layer.

### DETAILED DESCRIPTION

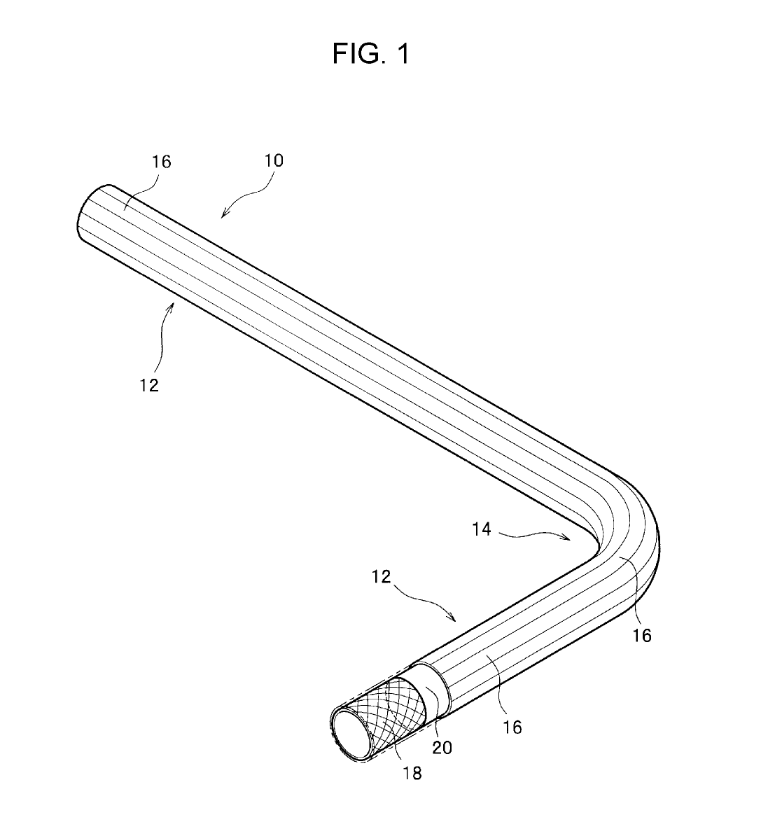

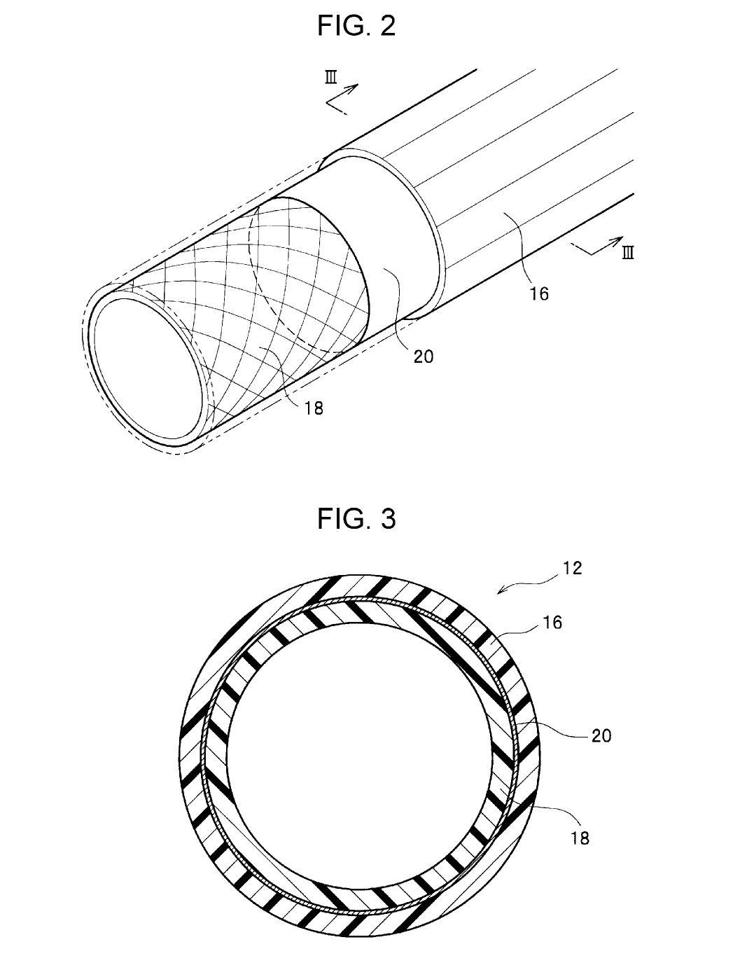

Next, an embodiment of the present disclosure will be described in detail with appropriate reference to the drawings. FIG. 1 is a perspective view of a shaft-shaped composite member produced by a production method for a shaft-shaped composite member according to an embodiment of the present disclosure, FIG. 2 is a partly enlarged transparent perspective view of the shaft-shaped composite member of FIG. 1, and FIG. 3 is a cross-sectional view taken along line III-III of FIG. 2.

A shaft-shaped composite member 10 produced by a production method according to this embodiment can be used for vehicle components such as a steering wheel, a suspension tower bar, a suspension arm, and a stabilizer. The shaft-shaped composite member 10 can also be used for components of sports or leisure goods, a bicycle handlebar, and a stroller.

As illustrated in FIG. 1, the shaft-shaped composite member 10 has a composite shape obtained by a combination of a linear part 12 having a substantially L-shaped portion and linearly or substantially linearly extending, and a nonlinear bent part 14.

In the shaft-shaped composite member 10 (linear part 12 and bent part 14), three layers are stacked in the radial direction. The three layers are each continuously formed in the circumferential direction. That is, the shaft-shaped composite member 10 is formed by stacking a 0° layer 16, a ±45° layer 18, and a stress relaxation layer 20. The 0° layer 16 is disposed on the radial outer side, and its orientation direction of carbon fiber (long fiber) is parallel to the axial direction of the shaft-shaped composite member 10. The ±45° layer 18 is disposed on the radial inner side, and its orientation direction of carbon fiber (long fiber) obliquely intersects the axial direction of the shaft-shaped composite member 10. The stress relaxation layer 20 is interposed between the 0° layer 16 on the radial outer side and the ±45° layer 18 on the radial inner side. The stress relaxation layer 20 has a flexural rigidity lower than that of the 0° layer 16 and a torsional rigidity lower than that of the ±45° layer 18.

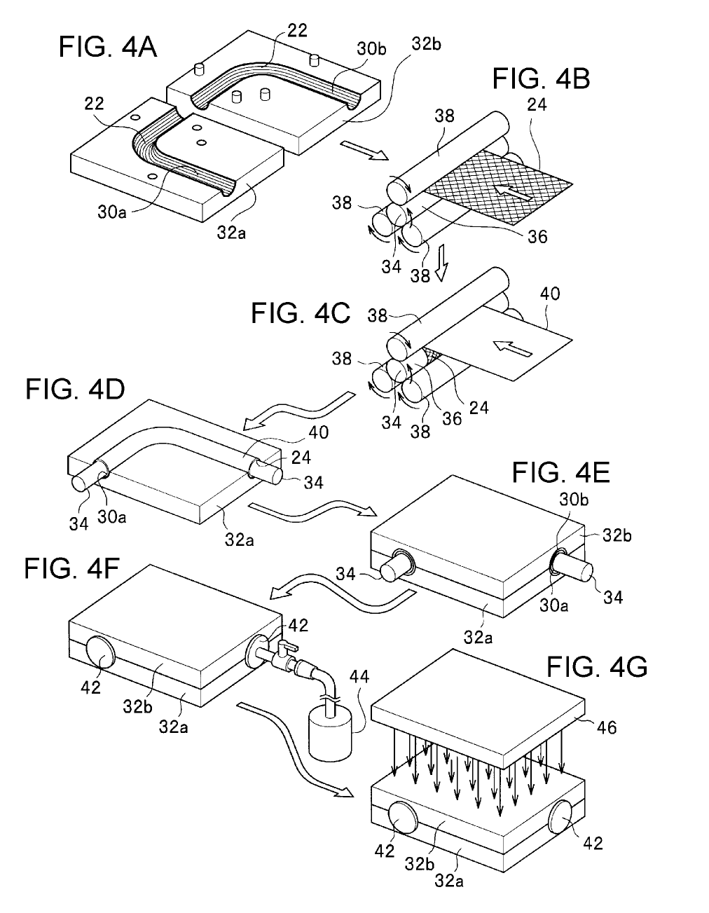

The 0° layer 16 is formed by a uni-directional (UD) material 22 (see FIG. 4A to be described later) in which fibers are arranged in an orientation direction serving as one direction parallel to the axial direction of the shaft-shaped composite member 10, and is made of a carbon fiber reinforced resin material. The ±45° layer 18 is formed by a prepreg (preferably, tow prepreg) 24 (see FIG. 4B to be described later) in which the orientation direction of carbon fibers obliquely intersects the axial direction of the shaft-shaped composite member 10. A tow prepreg is composed of multiple filaments in which carbon fibers serving as a reinforcing material are impregnated with resin serving as a matrix material. Examples of the resin include thermosetting resins such as epoxy resin, unsaturated polyester resin, polyurethane resin, diallyl phthalate resin, phenol resin, and polyimide resin.

For example, the stress relaxation layer 20 is formed by a prepreg 40 (see FIG. 4C to be described later) made of glass fiber reinforced plastic (GFRP) material having high tensile strength. By using this glass fiber reinforced plastic (GFRP) material, a chopped glass fiber layer (short fiber) having relatively low rigidity can be formed between the 0° layer 16 and the ±45° layer 18.

As illustrated in FIG. 3, the thicknesses of the three layers in the radial direction are set so that the thicknesses of the 0° layer 16 and the ±45° layer 18 are equal or substantially equal to each other and the thickness of the stress relaxation layer 20 is smaller than the thicknesses of the 0° layer 16 and the ±45° layer 18.

While each of the linear part 12 and the bent part 14 has the three-layer structure composed of the 0° layer 16, the stress relaxation layer 20, and the ±45° layer 18 in this embodiment, the structure is not limited thereto. It is only required that at least the bent part 14 should have the above-described three-layer structure, and the linear part 12 may be formed by two layers except for the stress relaxation layer 20, that is, the 0° layer 16 and the ±45° layer 18.

In the embodiment, for example, the 0° layer 16 located on the radial outer side has rigidity against the flexural load applied to the bent part 14 of the shaft-shaped composite member 10, and the ±45° layer 18 located on the radial inner side has rigidity against the torsional load. At this time, a specific stress may be generated on an interface between the layers because the layers have different rigidities. For this reason, in the embodiment, the stress relaxation layer 20 having a flexural rigidity lower than that of the 0° layer 16 and a torsional rigidity lower than that of the ±45° layer 18 is interposed between the 0° layer 16 and the ±45° layer 18. By forming the stress relaxation layer 20, the stress generated on the interface between the layers is relaxed, and this can increase strength (especially, fatigue strength applied repeatedly) of the interface. As a result, in the embodiment, it is possible to increase endurance by ensuring a predetermined strength of the bent part 14.

A conceivable method as an approach to increasing the strength is, for example, to increase the weight (rigidity) by increasing the thicknesses of the layers, instead of increasing the strength. According to the embodiment, however, the strength (especially, fatigue strength) can be increased without increasing the weight per unit dimension and without reducing rigidity, in contrast to the shaft-shaped composite member of the related art.

Next, a description will be given of a production method for producing a shaft-shaped composite member after forming two halved members by using an arranging device (not illustrated). FIGS. 4A to 4G are schematic views illustrating a production procedure for producing the shaft-shaped composite member.

First, a pair of molds 32a and 32b are prepared to form halved members 30a and 30b. The molds 32a and 32b have their respective cavities formed by grooves that are substantially L-shaped and have a semicircular cross section in top view (in plan view) in correspondence with the shape of the shaft-shaped composite member 10. The shapes of the grooves are symmetrical between one mold 32a and the other mold 32b. Carbon fiber reinforced resin materials withdrawn from a plurality of bobbins mounted in the unillustrated arranging device are juxtaposed parallel to the axial direction of the cavities, and are pressed along the grooves of the molds 32a and 32b, so that halved members 30a and 30b are formed. FIG. 4A illustrates a state in which the halved members 30a and 30b are formed in the grooves of the molds 32a and 32b, respectively.

The halved members 30a and 30b are formed of UD materials 22 (0° material), and form a 0° layer 16 whose orientation direction of carbon fiber is parallel to the axial direction of the shaft-shaped composite member 10. The carbon fiber reinforced resin materials are pressed against the grooves of the molds 32a and 32b until gap between the grooves and the carbon fiber reinforced resin materials are removed by a pressing section of the unillustrated arranging device. The specific configuration of the arranging device is described in the specification of Japanese Patent Application No. 2014-185328 filed by the present applicant, the entire contents of which are incorporated herein by reference.

In this way, a plurality of carbon fiber reinforced resin materials are disposed in a pair of molds 32a and 32b, and a pair of halved members 30a and 30b are formed by using the unillustrated arranging device. Creases are not made on the inner peripheral sides of bent parts of the halved members 30a and 30b formed by the unillustrated arranging device.

After the pair of halved members 30a and 30b are formed, for example, a resin mandrel (core) 34 is covered with a tubular bag (tube material) 36 formed of rubber, and a sheet-shaped prepreg 24 (preferably, tow prepreg) (±45° material) is wound around an outer surface of the tubular bag 36 by a sheet winding (SW) method (see FIG. 4B). At this time, the resin mandrel 34 covered with the tubular bag 36 is clamped by three rollers 38 arranged in substantially parallel, and is rotated by rotating the three rollers 38, so that the sheet-shaped prepreg 24 (±45° material) can be wound around the outer surface of the tubular bag 36.

After the prepreg 24 (±45° material) is wound around the outer surface of the tubular bag 36, a sheet-shaped prepreg 40 (stress relaxation material) formed of a glass fiber reinforced plastic material (GFRP) is further wound around an outer surface of the prepreg 24 (±45° material) by similarly rotating the three rollers 38 (see FIG. 4C).

In the embodiment, after the prepreg 24 (±45° material) is wound around the outer surface of the tubular bag 36, the prepreg 40 (stress relaxation material) of GFRP is wound to stack the two prepregs 24 and 40. For example, the prepregs 24 and 40 are stacked and wound around the outer surface of the tubular bag 36 in a manner such that a starting end of one prepreg 40 (stress relaxation material) is connected to a terminal end of the other prepreg 24 (±45° material). Alternatively, the one prepreg 40 (stress relaxation material) and the other prepreg 24 (±45° material) may be stacked beforehand and may be simultaneously wound around the outer surface of the tubular bag 36 by rotating the three rollers 38.

While the prepreg 24 (±45° material) and the prepreg 40 (GFRP, stress relaxation material) are wound by the sheet winding method in the embodiment, for example, filaments may be wound by a filament winding method.

Next, the resin mandrel 34 around which the prepreg 24 (±45° material) and the prepreg 40 (GFRP, stress relaxation material) are wound is fitted in the inner peripheral side of the halved member 30a formed in the mold 32a (see FIG. 4D), and the pair of molds 32a and 32b are closed (see FIG. 4E). After the pair of molds 32a and 32b are closed, the resin mandrel 34 is pulled out from the tubular bag 36, and plug members 42 are attached to opposite end portions of the tubular bag 36 (see FIG. 4F). For example, air of about 0.6 MPa is supplied from an air supply source 44 into a hollow portion of the tubular bag 36.

Further, after the resin is thermally set by performing heat treatment at a predetermined temperature by using a heater 46 (see FIG. 4G), mold opening is performed, and a shaft-shaped composite member 10 (see FIG. 1) serving as a molded article is taken out.

By carrying out this production method, the shaft-shaped composite member 10 composed of the layer of the ±45° material (±45° layer 18) located on the radial inner side, the UD material 22 (0° layer 16) located on the radial outer side, and the stress relaxation layer 20 (GFRP) interposed between the ±45° layer 18 and the 0° layer 16 can be obtained easily. Further, since the pair of molds 32a and 32b are used in the production method, the inner and outer peripheral difference in a bent part 14 is absorbed, and this can increase the strength of the bent part 14.

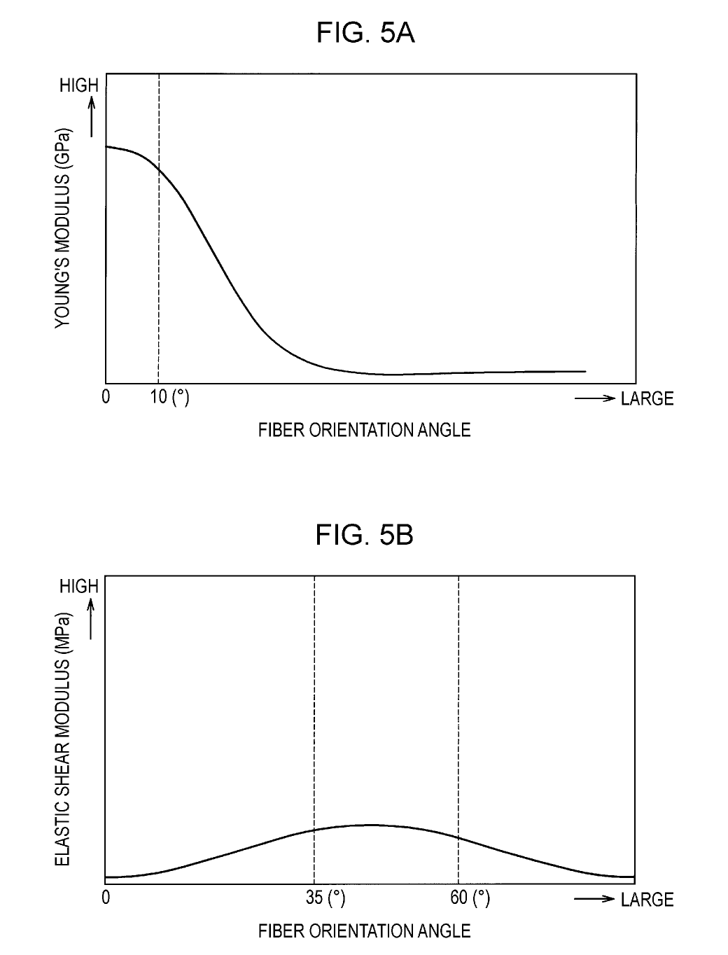

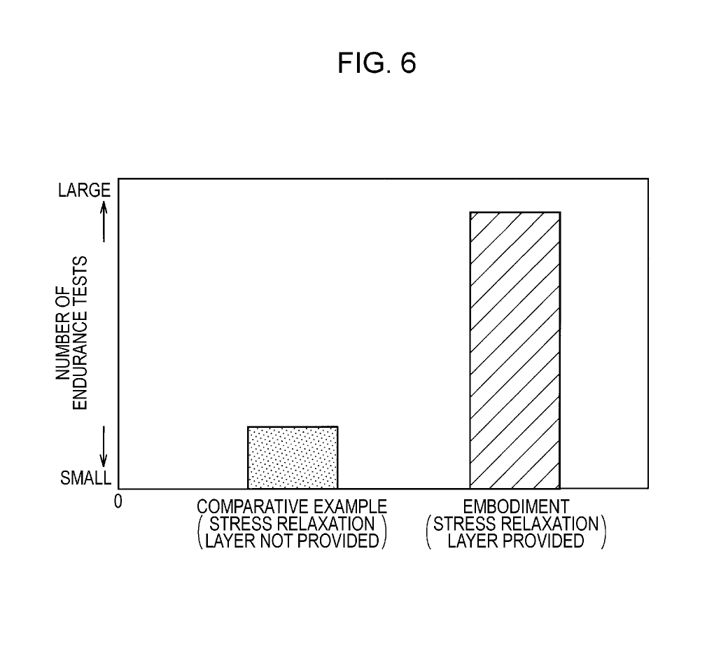

FIG. 5A is a characteristic view showing the relationship between the fiber orientation angle and the Young's modulus in the 0° layer, FIG. 5B is a characteristic view showing the relationship between the fiber orientation angle and the elastic shear modulus in the ±45° layer, and FIG. 6 is an explanatory view comparing endurances between a comparative example having no stress relaxation layer and the embodiment having a stress relaxation layer. Please note that the above-described comparative example is not a prior art.

In the shaft-shaped composite member 10 produced by the above-described production method, as illustrated in FIG. 5A, the fiber orientation angle of the 0° layer 16 located on the radial outer side is preferably set within the range of 0° to 10°. Further, as illustrated in FIG. 5B, the fiber orientation angle of the ±45° layer 18 located on the radial inner side is preferably set within the range of 35° to 60°.

Still further, as illustrated in FIG. 6, the number of endurance tests in a comparative example in which two layers, that is, the 0° layer 16 and the ±45° layer 18 are stacked without the stress relaxation layer 20 and the number of endurance tests in the embodiment having the stress relaxation layer 20 were compared. As a result of comparison, it was confirmed that endurance performance was enhanced about four or five times. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

We claim:

1. A shaft-shaped composite member comprising:
a bent part,
wherein the bent part comprises:
a first carbon fiber reinforced resin layer having a carbon fiber oriented in a direction substantially parallel to an axial direction of the shaft-shaped composite member,
a second carbon fiber reinforced resin layer having a carbon fiber oriented in a direction obliquely intersecting the axial direction of the shaft-shaped composite member, and
a stress relaxation layer interposed between the first carbon fiber reinforced resin layer and the second carbon fiber reinforced resin layer, and
wherein the stress relaxation layer is set to have a flexural rigidity lower than a flexural rigidity of the first carbon fiber reinforced resin layer and a torsional rigidity lower than a torsional rigidity of the second carbon fiber reinforced resin layer.

2. A production method for a shaft-shaped composite member having a bent part, the production method comprising the steps of:
placing a plurality of first carbon fiber reinforced resin materials substantially parallel to an axial direction of cavities of a pair of molds, the first carbon fiber reinforced resin materials having an orientation direction substantially parallel to an axial direction of the shaft-shaped composite member;
forming halved members by pressing the plurality of placed first carbon fiber reinforced resin materials against the cavities;
winding a second carbon fiber reinforced resin material having a carbon fiber oriented in a direction obliquely intersecting the axial direction of the shaft-shaped composite member on an outer surface of a tube material;
winding a stress relaxation material having a flexural rigidity lower than a flexural rigidity of the halved members and a torsional rigidity lower than a torsional rigidity of the second carbon fiber reinforced resin material on an outer surface of the second carbon fiber reinforced resin material;
inserting, into an inner side of the halved members, the tube material with the second carbon fiber reinforced resin material and the stress relaxation material stacked on the outer surface thereof and closing the pair of molds to form a tubular member; and
setting the tubular member by heating the tubular member while applying an internal pressure to the tubular member.

3. The shaft-shaped composite member according to claim 1, wherein the carbon fiber of the first carbon fiber reinforced resin layer has a fiber orientation angle of range of 0° to 10° (inclusive) with respect to the axial direction of the shaft-shaped composite member.

4. The shaft-shaped composite member according to claim 1, wherein the carbon fiber of the first carbon fiber reinforced resin layer has a fiber orientation angle of 0° with respect to the axial direction of the shaft-shaped composite member.

5. The shaft-shaped composite member according to claim 1, wherein the carbon fiber of the second carbon fiber reinforced resin layer includes a positive-angle fiber having a positive orientation angle with respect to the axial direction of the shaft-shaped composite member and a negative-angle fiber having a negative orientation angle with respect to the axial direction of the shaft-shaped composite member.

6. The shaft-shaped composite member according to claim 1, wherein the carbon fiber of the second carbon fiber reinforced resin layer has a fiber orientation angle of range of 35° to 60° (inclusive) with respect to the axial direction of the shaft-shaped composite member.

7. The shaft-shaped composite member according to claim 5, wherein the positive-angle fiber has a fiber orientation angle of range of 35° to 60° (inclusive) with respect to the axial direction of the shaft-shaped composite member.

8. The shaft-shaped composite member according to claim 5, wherein the negative-angle fiber has a fiber orientation angle of range of −35° to −60° (inclusive) with respect to the axial direction of the shaft-shaped composite member.

9. The shaft-shaped composite member according to claim 1, wherein the stress relaxation layer has a thickness smaller than a thickness of the first carbon fiber reinforced resin layer and a thickness of the second carbon fiber reinforced resin layer.

10. The shaft-shaped composite member according to claim 1 further comprising a straight part.

11. The production method according to claim 2, wherein the first carbon fiber reinforced resin materials have a fiber orientation angle of range of 0° to 10° (inclusive) with respect to the axial direction of the shaft-shaped composite member.

12. The production method according to claim 2, wherein the first carbon fiber reinforced resin materials have a fiber orientation angle of 0° with respect to the axial direction of the shaft-shaped composite member.

13. The production method according to claim 2, wherein the carbon fiber of the second carbon fiber reinforced resin material includes a positive-angle fiber having a positive orientation angle with respect to the axial direction of the shaft-shaped composite member and a negative-angle fiber having a negative orientation angle with respect to the axial direction of the shaft-shaped composite member.

14. The production method according to claim 2, wherein the carbon fiber of the second carbon fiber reinforced resin material has a fiber orientation angle of range of 35° to 60° (inclusive) with respect to the axial direction of the shaft-shaped composite member.

15. The production method according to claim 13, wherein the positive-angle fiber has a fiber orientation angle of range of 35° to 60° (inclusive) with respect to the axial direction of the shaft-shaped composite member.

16. The production method according to claim 13, wherein the negative-angle fiber has a fiber orientation angle of range of −35° to −60° (inclusive) with respect to the axial direction of the shaft-shaped composite member.

17. The production method according to claim 2, wherein the stress relaxation layer has a thickness smaller than a thickness of the each of the halves members and a thickness of the second carbon fiber reinforced resin material.

18. The production method according to claim 2, wherein the shaft-shaped composite member further comprises a straight part.

19. A vehicle comprising a shaft-shaped composite member according to claim 1.

20. The shaft-shaped composite member according to claim 1, wherein the first carbon fiber reinforced resin layer is disposed on an inner side of the shaft-shaped composite member and the second carbon fiber reinforced resin layer is disposed on an outer side of the shaft-shaped composite member.
